(19) United States
(12) Patent Application Publication
(10) Pub. No.: US 2013/0231418 A1
(43) Pub. Date: Sep. 5, 2013

(54) Incorporation of Lactones Into Crosslinked-Modified Polyols for Demulsification

(71) Applicants: Matthew Hilfiger, Richmond, TX (US); Patrick J. Breen, Houston, TX (US); Christine Ann Blundell, Ormskirk (GB); Jennifer Louise Sonne, Houston, TX (US)

(72) Inventors: Matthew Hilfiger, Richmond, TX (US); Patrick J. Breen, Houston, TX (US); Christine Ann Blundell, Ormskirk (GB); Jennifer Louise Sonne, Houston, TX (US)

(73) Assignee: BAKER HUGHES INCORPORATED, Houston, TX (US)

(21) Appl. No.: 13/865,619

(22) Filed: Apr. 18, 2013

Related U.S. Application Data
(63) Continuation-in-part of application No. 13/216,409, filed on Aug. 24, 2011.
(60) Provisional application No. 61/379,575, filed on Sep. 2, 2010.

(51) Int. Cl. B01D 17/04

(52) U.S. Cl. CPC B01D 17/047
USPC 523/414

(57) ABSTRACT

Crosslinked lactone/alkylene oxide polymers are useful as demulsifiers to break emulsions, e.g. water-in-oil and oil-in-water emulsions, particularly oilfield emulsions. These polymers are random or block polymers made from addition reactions of a hydroxyl- and/or amine-containing base compound with at least one lactone monomer and at least one alkylene oxide monomer. The polymers may be crosslinked with multifunctional epoxides, multifunctional carboxylic acids, and/or multifunctional anhydrides. The crosslinked polymers may be optionally capped by reaction with monofunctional monomers such as mono-epoxides and/or monofunctional carboxylic acids. The crosslinked polymers are also suitable as oilfield paraffin inhibitors and dispersants.

### CROSS-REFERENCE TO RELATED APPLICATIONS

This application is a continuation-in-part application of U.S. Ser. No. 13/216,409 filed Aug. 24, 2011, and also claims the benefit of U.S. Provisional Patent Application No. 61/641,091 filed May 1, 2012, all of which are incorporated herein in their entirety by reference.

### TECHNICAL FIELD

The present invention relates to demulsifiers, and more particularly relates in one non-limiting embodiment to demulsifiers that are crosslinked polymers of at least one lactone and at least one alkylene oxide.

### TECHNICAL BACKGROUND

Demulsifiers, or emulsion breakers, are a class of specialty chemicals used to separate or “break” emulsions (e.g. water-in-oil (w/o) emulsions or oil-in-water (o/w) emulsions) into a separate oil phase and a separate water phase. They are commonly used in the processing of crude oil, which is typically produced along with significant quantities of saline water. This water (and the salt) must be removed from the crude oil prior to refining. If the majority of the water and salt are not removed, significant corrosion problems can occur downstream in the refining process. Further, controlled emulsification, for instance in a desalter, and subsequent demulsification under controlled conditions are of significant value in removing impurities, particularly inorganic salts and other inorganic compounds, from crude oil.

Oilfield produced water may contain residual quantities of oil and sometimes solid particles. The oil may be valuable to recover and the water may need to have the oil removed prior to discharge into the environment. Water clarifiers help remove these residual amounts of oil that may be usefully recovered and to obtain clarified water that may be subsequently used in a water flood project or steam flood program, or safely introduced into the environment. It is conceivable that some polymers analogous to demulsifiers may be useful as water clarifiers, although usually water clarifies and demulsifiers cannot be assumed to be synonymous with each other. Further, it cannot be assumed that water clarifies and demulsifiers are substitutable for one another; generally they must be tried in a particular water clarification or demulsification process first.

Alkylene oxide polymers have long been known for their use in breaking emulsions. The industry is forever seeking better compositions and variations of these sorts of products that deliver better overall cost performance. Lower treating rates may be associated with being more environmentally sustainable since less demulsifier would be required. It would thus be very desirable and important to discover methods and compositions for economically and rapidly resolving or “breaking” petroleum emulsions.

### SUMMARY

There is provided, in one non-limiting form, a method of breaking an emulsion comprising oil and water. The method involves adding to the emulsion an effective amount of a crosslinked polymer to break the emulsion, where the polymer comprises a random or block polymer made from addition reactions of a hydroxyl- and/or amine-containing base compound with at least one lactone monomer and at least one alkylene oxide monomer, where the polymer has been crosslinked with a crosslinker. In addition to emulsion breaking these polymers are also suitable as oilfield paraffin inhibitors and dispersants.

### DETAILED DESCRIPTION

While the chemistry of lactone/alkylene oxide polymers has been known since the 1960s, (e.g. U.S. Pat. No. 2,962,524), it has been discovered that lactone/alkylene oxide polymers are useful as demulsifiers for o/w and w/o emulsions, particularly those that are encountered in the oilfield, but also in other industrial processing. They are also expected to be useful as oilfield paraffin inhibitors and dispersants.

The lactone/alkylene oxide polymers may be obtained by reacting a suitable hydroxyl- or amine-containing base compound with a suitable lactone monomer and an alkylene oxide monomer. Suitable hydroxyl- and/or amine-containing base compounds include, but are not necessarily limited to, methanol, propylene glycol, glycerol, pentaerythritol, sucrose, glucose, sorbitol, fructose, maltitol, polyvinyl alcohol, polysaccharides including starch derivatives, hydroxyl ethyl cellulose (HEC), carboxy methyl cellulose (CMC) and/or cyclodextrin, polyesters, polyethers, polyacids, polyamides, hydroxylamines, ethanolamine, diethanolamine, triethanolamine, polyethyleneimines, peptides and combinations thereof.

Suitable lactone monomers include, but are not necessarily limited to, those having 3 to 7 carbon atoms in the central ring, including those of

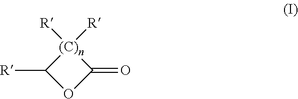

formula (I) where n is at least 1 and the R′ groups may each independently be any hydrogen, alkyl, cycloalkyl, or aromatic groups. In another non-limiting embodiment, n may range from 1 to 8; alternatively from 2 independently to 6. The R′ group may have from 1 to 15 carbon atoms. Particular suitable lactones include, but are not necessarily limited to, propiolactone, butyrolactone, valerolactone, caprolactone and mixtures thereof, including all structural isomers of these.

Suitable alkylene oxide monomers include, but are not necessarily limited to, ethylene oxide, propylene oxide, butylene oxide and mixtures thereof.

Suitable crosslinkers include, but are not necessarily limited to, multifunctional epoxides, multifunctional carboxylic acids, multifunctional anhydrides, isocyanates and combinations thereof. By “multifunctional” is meant two or more epoxide groups, two or more carboxylic acid groups, and/or two or more anhydride groups. It will be appreciated that crosslinkers having only one anhydride group may be effective since an acid anhydride has two acyl groups bound to the same oxygen. However, crosslinkers with two or more anhydride groups are expected to be relatively more effective. More specific examples of suitable crosslinkers include, but are not necessarily limited to, toluene di-isocyanate, MDI (methylene bis(phenylisocyanate)), poly MDI, polyethyleneglycol diepoxide, polypropyleneglycoldiepoxide, polyethylene-co-propyleneglycol diepoxide, N,N-diglycidyl-4-glycidyloxy aniline, 4,4′-methylenebis(N,N-diglycidylaniline), diepoxides of bisphenol A, maleic anhydride, phthalic anhydride, succinic anhydride, dodecenylsuccinic anhydride, adipic acid, succinic acid, tartaric acid, citric acid, malic acid, and the like.

In addition, these crosslinked polymers may be capped by reacting them with a suitable monofunctional capping monomer, including but not necessarily limited to styrene oxide, glycidal ether, benzylglycidal ether, C1-C24 glycidal ether, acid anhydrides, C2-C24 carbocyclic acids and other monoepoxides.

The weight ratio of at least one lactone monomer to the hydroxyl- or amine-containing base compound ranges from about 0.1:1 independently to about 99.9:1. Alternatively, the weight ratio of at least one lactone monomer to the hydroxyl- or amine-containing base compound ranges from about 1:99 independently to about 99:1, and in another non-limiting embodiment ranges from about 5:95 independently to about 95:5. The word “independently” as used herein with respect to ranges means that any lower threshold may be combined with any upper threshold to give an acceptable alternative range.

Similarly, the weight ratio of at least one alkylene oxide monomer to the hydroxyl- or amine-containing base compound ranges from about 0.1:1 independently to about 99.9:1. Alternatively, the weight ratio of at least one alkylene oxide monomer to the hydroxyl- or amine-containing base compound ranges from about 1:99 independently to about 99:1, and in another non-limiting embodiment ranges from about 10:90 independently to about 90:10.

The amount of crosslinker may range from about 0.1 independently to about 10 weight percent, based on the amount of polymer, and alternatively the amount of crosslinker may range from about 1 independently to about 5 weight percent, based on the amount of polymer.

The reaction conditions used to make the polymers described herein include a temperature range between about 100 independently to about 150° C., alternatively between about 120 independently to about 150° C., and the pressure preferably should not exceed about from about 60 to about 80 psi (about 0.4 to about 0.5 MPa). Solvents for these polymers are typically the liquid polyol starting materials themselves, but in some cases aromatic solvents have been utilized, for instance such as xylene. Suitable catalysts may be alkali metal hydroxides, including, but not necessarily limited to, NaOH and/or KOH.

If the crosslinker is a multifunctional epoxide, typical reaction conditions for the crosslinking could occur between about 60° C. independently to about 180° C.; alternatively from about 100° C. independently to about 140° C. If the crosslinker is a multifunctional carboxylic acid or anhydride, typical reaction conditions for the crosslinking could occur between about 100° C. independently to about 200° C.; alternatively from about 120° C. independently to about 180° C.

The polymers herein are structurally and chemically distinct from polymers made from the alkylation of phenol-formaldehyde resins. In one non-limiting embodiment, the crosslinked random or block copolymers herein have an absence of phenol-formaldehyde resins.

The weight average molecular weight of the crosslinked polymers described herein may range from about 2000 independently to about 1,500,000 g/mol; alternatively from about 4000 independently to about 500,000 g/mol. Some of the crosslinked polymer products, such as those based on the polyethyleneimine, could be near 1 million or greater in weight average molecular weight.

Effective demulsifying or water clarifying amounts or dosages of the crosslinked polymer to break the emulsion ranges from about 5 ppm independently to about 1000 ppm; alternatively, from about 25 independently to about 500 ppm.

The emulsions that may be resolved or broken using the crosslinked lactone/alkylene oxide polymers described herein are not necessarily limited to those o/w and/or w/o emulsions found in the production and refining of hydrocarbons, but may generally be used in breaking emulsions comprising oil and water in other contexts including, but not necessarily limited to, cleaning processes, pharmaceutical processing, food science, paint technology, etc.

The invention will now be illustrated with respect to certain Examples which are not intended to limit the invention, but instead to more fully describe it.

### EXAMPLES 1-6

Products A, B, C and D were all built off of a polyethyleneimine polyol. Product A was also modified not only by a mix of the lactone and propylene oxide, but by lactone/EO as well. Products B, C and D all used different amounts of lactone vs. propylene oxide, without any additional lactone added to the ethylene oxide (EO). Approximately, for Product B the ratio of lactone to propylene oxide was 1:4; for Product C it was about 1:5 and for Product D it was 1:3, where examples 1-6 use epsilon-caprolactone as the lactone.

Table I presents an example set of data presenting the percent water drop in emulsified crude oil samples from the North Sea which contained 45% BS&W (basic sediment and water). Concentration of the indicated products is in ppm. It may be seen that the compounds A, B, C and D are effective as emulsion breakers.

TABLE I
Percent Water Drop Using Various Lactone/Alkylene Oxide Polymers

| Ex. | Product | Concentration | 15 min. | 30 min. | 45 min. | 60 min. |
|---|---|---|---|---|---|---|
| 1 | A | 200 | 10 | 22 | 26 | 26 |
| 2 | A | 400 | 18 | 30 | 32 | 32 |
| 3 | B | 200 | 8 | 40 | 42 | 42 |
| 4 | B | 400 | 10 | 41 | 42 | 42 |
| 5 | C | 200 | 6 | 29 | 30 | 31 |
| 6 | D | 200 | 3 | 20 | 22 | 26 |

### EXAMPLES 7-11

Table II presents an example set of data for inventive products A, B, C and D and a comparative standard oilfield demulsifier presenting the percent water drop in emulsified crude oil samples from a North Sea platform which contained 45% BS&W (basic sediment and water). Concentration of all products is 300 ppm. It may be seen that the compound D is effective as emulsion breakers and give improved results when compared to a standard oilfield demulsifier. Compounds A, B and C show comparable performance to a standard oilfield demulsifier.

TABLE II
Percent Water Drop on Oil from North Sea Platform 1

300 ppm
Treatment, min.

| Ex. | | 15 | 30 | 45 | 60 |
|---|---|---|---|---|---|
| 7 | Standard Oilfield Demulsifier | 9 | 35 | 35 | 39 |
| 8 | A | 6 | 29 | 30 | 31 |
| 9 | B | 3 | 20 | 22 | 26 |
| 10 | C | 18 | 30 | 30 | 32 |
| 11 | D | 10 | 41 | 42 | 42 |

### EXAMPLES 12-16

Table III presents another example set of data for inventive products A, B, C and D and a comparative standard oilfield demulsifier presenting the percent water drop and % BS&W in emulsified crude oil samples from a North Sea platform. Concentration of all products is 300 ppm. It may be seen that the compounds A, B, C and D are effective as emulsion breakers and give improved results when compared to a standard oilfield demulsifier.

TABLE III
Percent Water Drop and BS&W on Oil from North Sea Platform 2

| Ex. | 300 ppm Treatment, min. → | 2 | 4 | 7 | 10 | BS&W |
|---|---|---|---|---|---|---|
| 12 | Standard Oilfield Demulsifier | 5 | 19 | 22 | 40 | 0.8 |
| 13 | A | 19 | 32 | 61 | 74 | 1.2 |
| 14 | B | 25 | 40 | 70 | 75 | 1 |
| 15 | C | 19 | 30 | 70 | 72 | 1 |
| 16 | D | 15 | 30 | 70 | 71 | 0.8 |

It is expected that all of the polymers described above may be crosslinked using the crosslinkers and methods previously discussed.

It is further anticipated that the crosslinked polymers described herein will also be effective in oilfield hydrocarbons as paraffin inhibitors and in oilfield fluids more generally as dispersants.

It is to be understood that the invention is not limited to the exact details of monomers, reaction conditions, proportions, etc. shown and described, as modifications and equivalents will be apparent to one skilled in the art. The invention is therefore to be limited only by the scope of the appended claims. Further, the specification is to be regarded in an illustrative rather than a restrictive sense. For example, specific combinations of lactone monomers, alkylene oxide monomers, hydroxyl- and/or amine-containing base compounds or starting materials, crosslinkers reactant proportions, reaction conditions, molecular weights, dosages and the like falling within the described parameters herein, but not specifically identified or tried in a particular method or apparatus, are anticipated to be within the scope of this invention.

The terms “comprises” and “comprising” used in the claims herein should be interpreted to mean including, but not limited to, the recited elements.

The present invention may suitably comprise, consist or consist essentially of the elements disclosed and may be practiced in the absence of an element not disclosed. For instance, the crosslinked polymer may consist of or consist essentially of the lactone monomers, alkylene oxide monomers and hydroxyl- or amine-containing base compounds or starting materials and crosslinkers recited in the claims. Alternatively, the method of breaking an emulsion comprising oil and water may consist of or consist essentially of adding to the emulsion comprising oil and water an effective amount of a crosslinked polymer to break the emulsion, where the crosslinked polymer comprises a random or block polymer made from addition reactions of a hydroxyl- and/or amine-containing base compound with at least one lactone monomer and at least one alkylene oxide monomer, where the polymer has been crosslinked with a crosslinker.

What is claimed is:

1. A method of breaking an emulsion comprising oil and water, the method comprising:
adding to the emulsion comprising oil and water an effective amount of a crosslinked polymer to break the emulsion, where the crosslinked polymer comprises a random or block polymer made from addition reactions of a base compound selected from the group consisting of hydroxyl-containing base compound, an amine-containing base compound, and combinations thereof, with at least one lactone monomer and at least one alkylene oxide monomer, where the polymer has been crosslinked with a crosslinker.

2. The method of claim 1 where:
the at least one lactone monomer is selected from the group of lactones of formula (I) having from 3 to 7 carbon atoms in the central ring 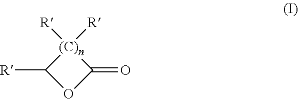
where n is at least 1 and R′ are independently hydrogen, alkyl, cycloalkyl, or aromatic group; and
the at least one alkylene oxide monomer is selected from the group consisting of ethylene oxide, propylene oxide, butylene oxide, and mixtures thereof;
the hydroxyl- or amine-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC), and cyclodextrin; polyesters; polyethers; polyacids; polyamides; hydroxylamines; polyethyleneimines; peptides; and combinations thereof; and
the crosslinker is selected from the group consisting of multifunctional epoxides, multifunctional carboxylic acids, multifunctional anhydrides, isocyanates, and combinations thereof.

3. The method of claim 2 where the hydroxyl- or amine-containing base compound is a hydroxylamine that is selected from the group consisting of ethanolamine, diethanolamine, triethanolamine, and mixtures thereof.

4. The method of claim 1 where:
the weight ratio of at least one lactone monomer to the hydroxyl- or amine-containing base compound ranges from about 0.1:1 to about 99.9:1; and
the weight ratio of at least one alkylene oxide monomer to the hydroxyl- or amine-containing base compound ranges from about 99.9:1 to about 0.1:1.

5. The method of claim 1 where the amount of crosslinker ranges from between about 0.1 and about 10 weight percent, based on the polymer.

6. The method of claim 1 where the weight average molecular weight of the crosslinked polymer ranges from about 2000 to about 1,500,000 g/mol.

7. The method of claim 1 where the effective amount of the crosslinked polymer ranges from about 5 to about 1000 ppm, based on the emulsion.

8. The method of claim 1 where the crosslinked polymer is capped by reaction with monofunctional monomers selected from the group consisting of monoepoxides, monofunctional carboxylic acids and combinations thereof.

9. The method of claim 8 where the monofunctional monomer is selected from the group consisting of styrene oxide, glycidal ether, benzylglycidal ether, C1-C24 glycidal ether, acid anhydrides, C2-C24 carbocyclic acids and combinations thereof.

10. A method of breaking an emulsion comprising oil and water, the method comprising:
adding to the emulsion comprising oil and water from about 5 to about 1000 ppm, based on the emulsion, of a crosslinked polymer to break the emulsion, where the crosslinked polymer comprises a random or block polymer having a weight average molecular weight of the polymer ranges from about 2000 to about 1,500,000 g/mol made from addition reactions of a base compound selected from the group consisting of hydroxyl-containing base compound, an amine-containing base compound, and combinations thereof, with at least one lactone monomer and at least one alkylene oxide monomer, where the polymer has been crosslinked with a crosslinker.

11. The method of claim 10 where:
the at least one lactone monomer is selected from the group of lactones of formula (I) having from 3 to 7 carbon atoms in the central ring 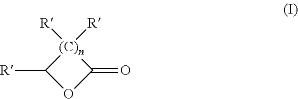
where n is at least 1 and R′ are independently hydrogen, alkyl, cycloalkyl, or aromatic group; and
the at least one alkylene oxide monomer is selected from the group consisting of ethylene oxide, propylene oxide, butylene oxide, and mixtures thereof; and
the hydroxyl- or amine-containing base compound is selected from the group consisting of methanol; propylene glycol; glycerol; pentaerythritol; sucrose; glucose; sorbitol; fructose; maltitol; polyvinyl alcohol, polysaccharides selected from the group consisting of starch derivatives, hydroxyl ethyl cellulose (HEC), carboxy methyl cellulose (CMC), and cyclodextrin; polyesters; polyethers; polyacids; polyamides; hydroxylamines; polyethyleneimines; peptides; and combinations thereof; and
the crosslinker is selected from the group consisting of multifunctional epoxides, multifunctional carboxylic acids, multifunctional anhydrides, isocyanates, and combinations thereof.

12. The method of claim 11 where the hydroxyl- or amine-containing base compound is a hydroxylamine that is selected from the group consisting of ethanolamine, diethanolamine, triethanolamine, and mixtures thereof.

13. The method of claim 10 where:
the weight ratio of at least one lactone monomer to the hydroxyl- or amine-containing base compound ranges from about 0.1:1 to about 99.9:1; and
the weight ratio of at least one alkylene oxide monomer to the hydroxyl- or amine-containing base compound ranges from about 99.9:1 to about 0.1:1.

14. The method of claim 10 where the amount of crosslinker ranges from between about 0.1 and about 10 weight percent, based on the polymer.

15. The method of claim 10 where the crosslinked polymer is capped by reaction with monofunctional monomers selected from the group consisting of monoepoxides, monofunctional carboxylic acids, and combinations thereof.

16. The method of claim 15 where the monofunctional monomer is selected from the group consisting of styrene oxide, glycidal ether, benzylglycidal ether, C1-C24 glycidal ether, acid anhydrides, C2-C24 carbocyclic acids and combinations thereof.

17. A method of breaking an emulsion comprising oil and water, the method comprising:
adding to the emulsion comprising oil and water from about 5 to about 1000 ppm, based on the emulsion, of a crosslinked polymer to break the emulsion, where the crosslinked polymer comprises a random or block polymer made from addition reactions of a base compound selected from the group consisting of hydroxyl-containing base compound, an amine-containing base compound, and combinations thereof, with at least one lactone monomer and at least one alkylene oxide monomer, where the polymer has been crosslinked with a crosslinker, and where:
the at least one lactone monomer is selected from the group of lactones of formula (I) having from 3 to 7 carbon atoms in the central ring 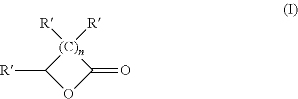
where n is at least 1 and R′ are independently hydrogen, alkyl, cycloalkyl, or aromatic group; and
the at least one alkylene oxide monomer is selected from the group consisting of ethylene oxide, propylene oxide, butylene oxide and mixtures thereof;
the hydroxyl- or amine-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC) and cyclodextrin; polyesters; polyethers; polyacids; polyamides; hydroxylamines; polyethyleneimines; peptides; and combinations thereof; and
the crosslinker is selected from the group consisting of multifunctional epoxides, multifunctional carboxylic acids, multifunctional anhydrides, isocyanates, and combinations thereof.

18. The method of claim 17 where the hydroxyl- or amine-containing base compound is a hydroxylamine that is selected from the group consisting of ethanolamine, diethanolamine, triethanolamine, and mixtures thereof.

19. The method of claim 17 where:
the weight ratio of at least one lactone monomer to the hydroxyl- or amine-containing base compound ranges from about 0.1:1 to about 99.9:1; and
the weight ratio of at least one alkylene oxide monomer to the hydroxyl- or amine-containing base compound ranges from about 99.9:1 to about 0.1:1.

20. The method of claim 17 where the amount of crosslinker ranges from between about 0.1 and about 10 weight percent, based on the polymer.
